(19) United States
(12) Patent Application Publication
(10) Pub. No.: US 2015/0144844 A1
(43) Pub. Date: May 28, 2015

(54) COMPOSITES INCORPORATING A CONDUCTIVE POLYMER NANOFIBER NETWORK

(71) Applicant: University of Washington through its Centre for Commercialization, Seattle, WA (US)

(72) Inventors: Lilo Danielle Pozzo, Seattle, WA (US); Gregory Newbloom, Seattle, WA (US)

(73) Assignee: University of Washington through its Center for Commercialization, Seattle, WA (US)

(21) Appl. No.: 14/389,708

(22) PCT Filed: Apr. 4, 2013
(86) PCT No.: PCT/US2013/034835

§ 371 Date: Sep. 30, 2014

Related U.S. Application Data
(60) Provisional application No. 61/618,126, filed on Mar. 30, 2012.

(51) Int. Cl. H01B 1/12

(52) U.S. Cl. CPC H01B 1/127; H01B 1/124
USPC 252/500

(57) ABSTRACT

Methods of forming composites that incorporate networks of conductive polymer nanofibers are provided. Networks of less-than conductive polymers are first formed and then doped with a chemical dopant to provide networks of conductive polymers. The networks of conductive polymers are then incorporated into a matrix in order to improve the conductivity of the matrix. The formed composites are useful as conductive coatings for applications including electromagnetic energy management on exterior surfaces of vehicles.

### CROSS-REFERENCE TO RELATED APPLICATION

This application claims the benefit of U.S. Provisional Application No. 61/618,126, filed Mar. 30, 2012, the disclosure of which is hereby incorporated by reference in its entirety.

### STATEMENT OF GOVERNMENT LICENSE RIGHTS

This invention was made with government support under contract number DESC0005153, awarded by the U.S. Department of Energy. The government has certain rights in the invention.

### BACKGROUND

Carbon fiber reinforced composites (CFRC) result in significant reductions in weight due to their lower density (1.5-1.8 g/cm³) when compared to aluminum alloys (2.7 g/cm³). CFRC are particularly of interest in the manufacture of vehicles, including airplanes and land vehicles such as cars and trucks. Furthermore, the use of composites simplifies manufacturing processes and leads to stronger components with higher durability. Expected increases in fuel costs will continue to motivate the use of composites in vehicle designs in the future.

Despite having clear advantages in weight reduction and fuel savings, the use of resin-based composites in modern vehicles presents new engineering challenges. Some of these stem from the dielectric nature of the resins that are used to prepare the CFRC. Traditional metallic components have high conductivity (Aluminum ˜3.6×10⁷ S/m). Carbon fibers in CFRC significantly increase the effective conductivity (CFRC ˜1.5×10⁴ S/m) but, because they are buried inside the material, large currents can cause structural damage. For these reasons, electromagnetic effect (EME) management of CFRC in vehicles (particularly airplanes) is especially important.

In particular, the mitigation of risks associated with lightning strikes is of high relevance to aircraft design. It is estimated that FAA-approved commercial airplanes are struck by lightning an average of two times every year. The primary lightning event (main stroke) requires dissipation of up to 200,000 Amperes over sub-millisecond timescales. When a suitable conductive path is not present, mechanical damage, thermal degradation and/or damage to electronic components can result. Moreover, lightning-related events such as corona discharge, streamers, and continuing currents can also persist before or after the main stroke exits the airplane. These events can result in serious damage to physical and electronic components even when not in the exit path of the main stroke. For example, continuing currents can also be significant (up to 200 Amperes) and need to be dissipated effectively.

The other main EME problem of importance is static charge buildup during normal flight conditions. Static charge can originate from the impact of airborne particles, rain or snow (i.e. triboelectric charging) or from the flow of hydraulic fluids or fuel. Static charge buildup hinders communications, interferes with electronic equipment and can lead to sparks and explosions in the presence of flammable vapors. The increased use of electronic navigation systems in modern aircrafts (e.g. fly-by-wire) that may be affected by static buildup further motivates the need for effective charge dissipation.

Current strategies for lightning and EME management in planes containing CFRCs consist of incorporating a conductive metallic mesh (e.g. Cu or Al) between upper plies of the composite. This allows effective current dissipation along the surface of the plane without penetrating deep into the composite material. Although this is an effective damage prevention strategy, it can add significant weight to the plane (Cu density is 8.9 g/cm³), reducing the magnitude of fuel savings. For this reason, metallic meshes are only added to critical sections of the planes such as those with high probability of lightning strike or where damage can be critical (e.g. fuel tanks).

A more powerful mitigation strategy that is also being explored is the use of conductive finishes (i.e. coatings) on the upper surfaces of the plane.

Because of their location, sacrificial conductive coatings can potentially dissipate enough electric current to prevent more serious damage to underlying structural and electronic components. Although lightning will irreversibly damage the coatings, these can be easily removed and reapplied. In contrast, damage to composite parts requires full replacement of the affected area at a much higher cost. Current commercial conductive finishes are usually composed of silver or copper particles dispersed within epoxy, acrylic or polyurethane carriers. The use of metallic particles leads to low sheet resistances (˜0.1 Ohm/sq for 0.05 mm thickness) but the creation of a connected conductive path (percolation) requires very high particle loadings (>50 wt %). This also translates to very large mass densities (>4 g/cm³) for the resulting coatings, adding to the total aircraft weight and reducing fuel savings. More importantly, the high particle loading requirements significantly deteriorate the mechanical and adhesive properties of the coatings so that they may not meet aerospace requirements.

Ideally, one would create conductive finishes that have low sheet resistances, low mass densities and which do not affect the adhesive and mechanical properties of existing coatings that have been optimized for this application. Conductive nanomaterials have been proposed as possible conductive finishes. The dispersion of conductive nanomaterials including carbon nanotubes, graphene, and nanoparticles into organic resins has been explored in order to modify the electronic properties of composite materials. Although some of these strategies show substantial promise, there are also significant problems preventing their application in conductive finishes. For example, carbon nanotubes have low percolation thresholds (˜0.5 wt %) and show significant increases in conductivity at higher concentrations (e.g. ˜0.2 S/m at 1 wt %). However, these changes are also followed by large increases in viscosity that makes coating difficult. There are also concerns about the toxicity of nanotubes and the potential for stronger regulation in the future.

Therefore, improved conductive finishes are desirable in order to advance the production of CFRCs and similar technologies.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a method of forming a composite incorporating networks of conductive polymer nanofibers is provided. In one embodiment, the method includes the steps of:

(a) providing a colloidal dispersion comprising a self-assembled network of a conjugated polymer;

(b) doping the conjugated polymer with a chemical dopant to provide conductive polymers within the self-assembled network of the colloidal dispersion; and

(c) dispersing the colloidal dispersion within a liquid matrix to provide a liquid composite comprising a network of conjugated polymer nanofibers, wherein the liquid matrix is selected from the group consisting of a polymer and a polymer precursor.

In another aspect, an electromagnetic effect (EME) management system for a vehicle exterior is provided. In one embodiment, the EME management system includes:
an exterior surface of a vehicle; and
a composite layer disposed on the exterior surface, the composite layer comprising a network of conductive polymer nanofibers in a solid polymer matrix.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1D schematically illustrate representative methods of forming composites incorporating polymer nanofiber networks in accordance with the disclosed embodiments.

FIG. 1E schematically illustrates the effect of chemical doping of conjugated polymers on nanofiber networks formed before and after doping.

FIG. 2 illustrates representative conjugated polymers useful in the disclosed embodiments.

FIG. 3 illustrates TEM micrographs of P3HT nanofiber networks self-assembled in various solvents.

FIG. 4 illustrates the formation of stable networks of P3HT in epoxy (BADGE) in accordance with the disclosed embodiments.

FIG. 5 illustrates TEM micrographs of nanostructured P3HT formed in xylene through self-assembly triggered by a temperature change from 80° C. to −20° C.

FIG. 6 illustrates SEM micrographs of deposited colloidal particles after doping conjugated polymer nanofiber networks contained therein with iodine.

FIG. 7 graphically illustrates small angle x-ray scattering (SAXS) profiles of P3HT self-assembled in toluene at a concentration of 0.2 wt % and at a temperature of −20° C. after dissolution at 80° C.

FIG. 8 graphically illustrates bulk conductivity of nanostructured P3HT colloidal networks, formed in xylene through a temperature change, as a function of concentration and doping (excess iodine). Percolation thresholds are in the range of 0.3 to 0.6 wt % filler.

FIG. 9 graphically illustrates bulk conductivity of a P3HT dispersion doped with iodine (in excess) and dispersed in pure epoxy precursor (BADGE or bisphenol A diglycidyl ether) as a function of shear rate. Measurement is performed in a rheometer with 25 mm parallel plates. Conductivity improves or is maintained during shear flow up to shear rates of 10 s⁻¹. Also illustrated is a schematic and picture of the rheo-dielectric testing apparatus.

FIG. 10 illustrates images of a film of P3HT doped with iodine after self-assembly and dispersed at a concentration of 1.2 wt % in a commercial polyurethane formulation. The conductive film is flexible and retains the properties of pure polyurethane films because of the low filler loading fractions.

FIG. 11 illustrates SEM micrographs of common nanostructures formed from conjugated polymers.

FIG. 12 is a circuit model and Nyquist plot of the impedance of a doped P3HT network in uncured epoxy.

### DETAILED DESCRIPTION

Methods of forming composites that incorporate networks of conductive polymer nanofibers are provided. Networks of less-than conductive polymers are first formed and then doped with a chemical dopant to provide networks of conductive polymers. The networks of conductive polymers are then incorporated into a matrix in order to improve the conductivity of the matrix.

In one aspect, a method of forming a composite incorporating networks of conductive polymer nanofibers is provided. In one embodiment, the method includes the steps of:

(a) providing a colloidal dispersion comprising a self-assembled network of a conjugated polymer;

(b) doping the conjugated polymer with a chemical dopant to provide conductive polymers within the self-assembled network of the colloidal dispersion; and

(c) dispersing the colloidal dispersion within a liquid matrix to provide a liquid composite comprising a network of conjugated polymer nanofibers, wherein the liquid matrix is selected from the group consisting of a polymer and a polymer precursor.

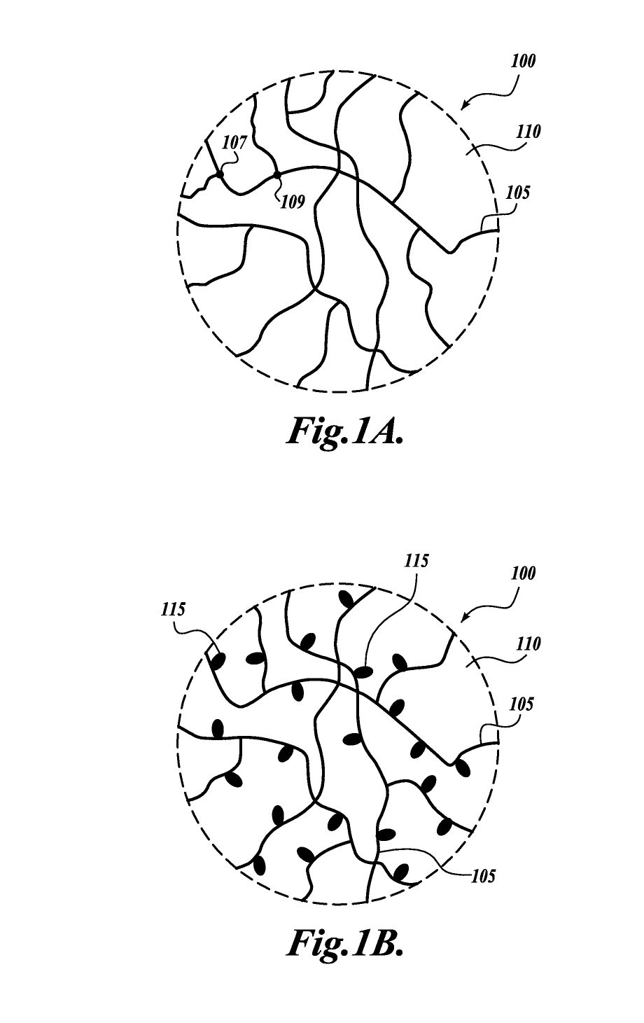

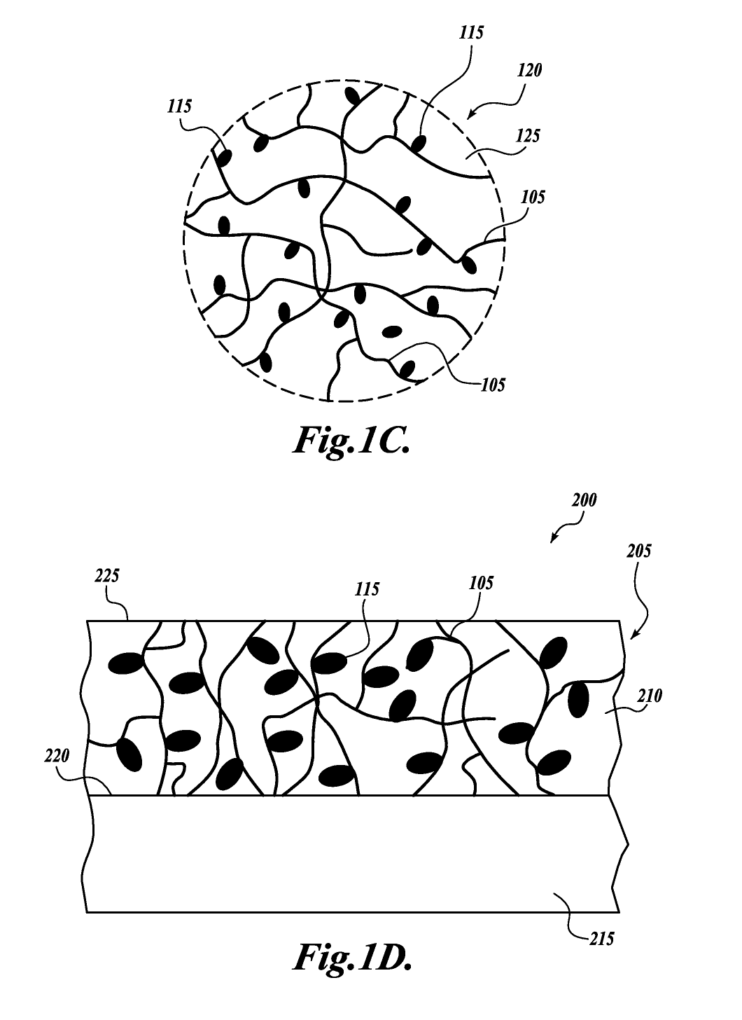

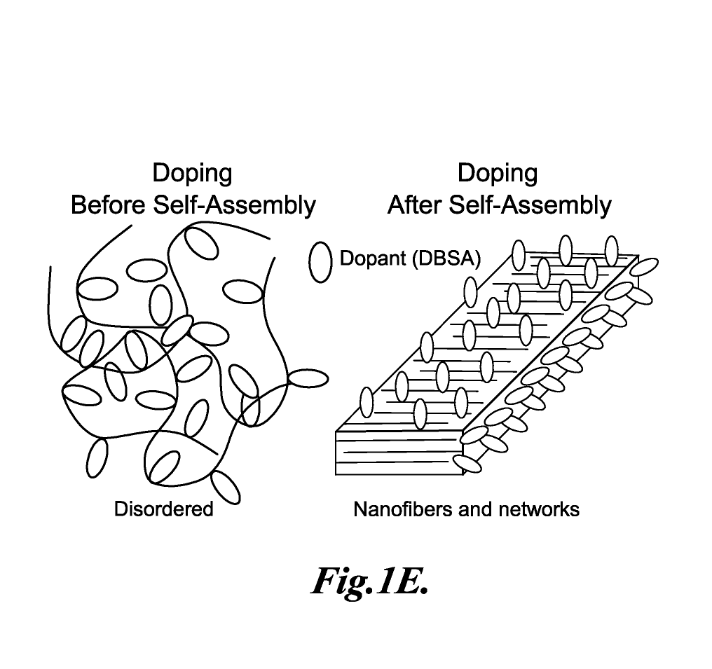

The disclosed methods may be better understood with reference to the experimental descriptions below, as well as the attached FIGURES. Referring to FIGS. 1A-1C, the steps of the method will be described.

FIG. 1A illustrates a colloidal dispersion 100 comprising a self-assembled network of conjugated polymer nanofibers 105 in a solvent 110. The composition of the colloidal dispersion 100 will be described in greater detail below.

“Colloidal dispersion” is defined as a conjugated polymer network structure that is suspended in a solvent. This suspended structure in its entirety can be on the order of 100 nm or larger, but may contain components that exist on a much smaller size scale (i.e. some conjugated polymers form fiber that are on the order of 5 nm in thickness and 20 nm in width). The smaller, interconnected components make up the larger network structure that is suspended in the solvent.

Referring to FIG. 1B, the colloidal dispersion 100 of FIG. 1A is then doped with a chemical dopant 115, which has the effect of increasing the conductivity of the nanofibers and the colloidal dispersion 100.

Referring to FIG. 1C, the colloidal dispersion 100 of FIG. 1B is then transferred to and dispersed in a liquid matrix 125 to provide a liquid composite 120 comprised of a network of conductive polymer nanofibers. The liquid matrix 125 includes a polymer or a polymer precursor.

In one embodiment, the network of conductive polymers comprises fibers having an individual length of from 50 nm to 5 microns.

In one embodiment, the network of conductive polymers comprises fibers having a cross-sectional dimension of from 5 nm to 200 nm.

In one embodiment, the network of conductive polymers comprises fibers having a plurality of branch points spaced between 200 nm to 5 microns apart. As used herein, “branch points” refers to the locations along a polymer chain 105 where the polymer branches into side chains. Referring to FIG. 1A, branches are illustrated at 107 and 109. The distance between branch points is the distance between 107 and 109.

In one embodiment, the colloidal dispersion is from 1 micron to 1 mm in size. The size of the colloidal dispersion is defined by its largest measurable dimension (e.g., width). The shape of typically colloidal dispersions is irregular.

In one embodiment, the method further comprises a step of solidifying the liquid composite to provide a solid composite comprising a network of conjugated polymer nanofibers in a solid polymer matrix. Referring to FIG. 1D, the liquid composite 120 of FIG. 1C can then be applied to a substrate 215 in order to form a solid composite 205. The solid composite 205 includes a solid polymer matrix 210 that is the solidified embodiment of the liquid matrix 125 from FIG. 1C (e.g., a polymerized polymer precursor or a solidified polymer). The solid composite 205 also includes conductive polymers comprising a conjugated polymer nanofiber network 105 doped with chemical dopants 115. The combined assembly 200 provides a conductive surface to the substrate 215 that includes a plurality of conductive paths, via the nanofiber network 105 from the substrate surface 220 to the composite surface 225.

In the representative embodiment where the substrate 215 is a vehicle exterior surface, the solid composite 205 provides an EME management layer. Representative substrates 215 include non-conductive structural materials, such as CRFCs. Representative vehicles include airplanes and automobiles (e.g., cars, trucks, and motorcycles).

The disclosed embodiments use conjugated polymer nanostructures as additives to generate finishes for electromagnetic effect (EME) management applications on carbon fiber reinforced composites (CFRC). Conjugated polymers (CP) have delocalized electrons in π orbitals along the backbone. Charge transport can occur along the chain by resonant transfer or via inter-chain “hopping” when polymers are packed sufficiently close to each other (e.g. via π-π stacking in nanofibers).

Conjugated polymers are not considered “conductive polymers” for the purposes of this disclosure, unless doped with a chemical dopant. In this regard, “conductive polymers” incorporated into a nanofiber network and including the chemical dopant, have a conductivity of 10⁻⁹ S/sq or greater (i.e., 10⁹ Ohm/sq or less).

Representative CPs include polythiophenes, polyfluorenes, polyacetylene, polyanililine and polyphenylenes with various substitution moieties (e.g. alkanes) that are added to improve solubility in organic solvents. In one embodiment, the conjugated polymer is a semiconducting polymer. Conjugated polymers by themselves are typically, at the most, semiconducting. Therefore, conjugated polymers must be doped, as provided herein, in order to become sufficiently conductive to form a conductive composite.

In one embodiment, the conjugated polymer is organic-soluble. As used herein, the term “organic soluble” refers to a conjugated polymer that can dissolve in an organic solvent at concentrations that are equal or greater than 0.1 mg/mL.

In one embodiment, the conjugated polymer is selected from the group consisting of a polyalkylthiophene, a polydi-alkyl fluorene, a polydithienosilole, a polyphenylene, a poly(3,4-ethylenedioxythiophene), a poly(pyrrole), a polypyrene, a polypyridine, a poly(p-phenylene vinylene), a polycarbazole, a polyaniline, a polyindole, and a copolymer of the polymers listed within this group.

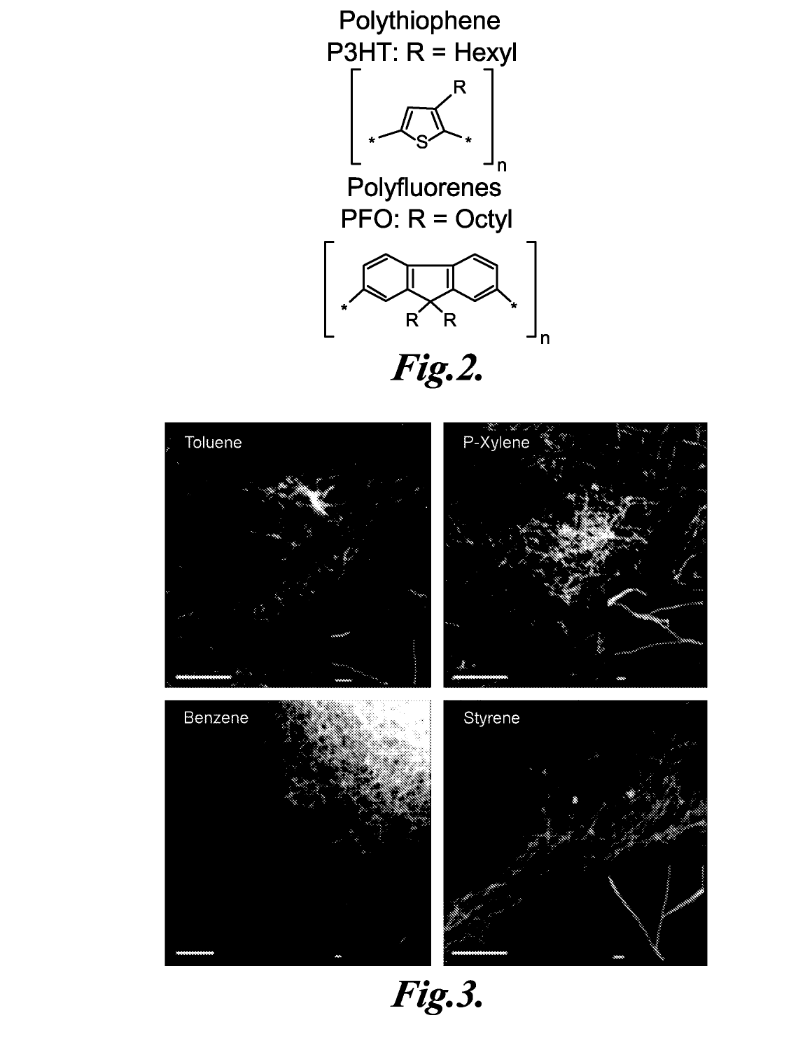

FIG. 2 shows chemical structures of two representative CP types useful in the disclosed embodiments: polythiophene (e.g. P3HT) and polyfluorene (e.g. PFO).

Although largely unexplored in this context, CPs have potential advantages for the creation of advanced conductive finishes for CFRC in various applications, including the aerospace industry. First, their density (˜1.1 g/cm³) matches that of the resins so that they do not add significant weight to the coating. Their chemical nature also results in favorable chemical interactions with resin monomers so that they are stable in dispersion.

CPs useful in the provided embodiments possess strong tendencies to self-assemble into long nanofibers and to form networked nanostructures. The self-assembly process is usually triggered by the reduction of the polymer solubility and it is readily controlled by changing temperature or by adding miscible non-solvents. The formation of these supra-molecular nanostructures through self-assembly leads to sufficient electronic percolation and to effective charge propagation.

Several CPs, including P3HT and PFO have been shown to readily form stable nanofiber network dispersions and organogels when dissolved in aromatic solvents at variable temperatures. Nanofiber networks and organogels provide clear paths for charge transport over long distances because they are intrinsically connected. Furthermore, inducing self-assembly under different conditions readily modifies the structural parameters of the nanofiber network including the branching density (FIG. 3).

Network structures and gels have also been observed in several other CP systems suggesting that it is a common effect that originates from π-π stacking interactions. The formation of self-assembled fibers and networks can result in multiple-order increases in conductivity due to increased conjugation length, crystalline order and percolation.

In one embodiment, the colloidal dispersion is formed by temperature-induced self-assembly of the conjugated polymer in a solution.

In one embodiment, the colloidal dispersion is a fluid colloidal dispersion.

In one embodiment, the colloidal dispersion is prepared from the mechanical fracture of a gel.

In one embodiment, the gel is an elastic organogel comprising the self-assembled network of the conjugated polymer.

There is a strong correlation between the state of organization of the CPs and their electronic properties. Lastly, because they are normally p-type semiconductors, the intrinsic conductivity of CPs is initially low but can increase by multiple orders of magnitude upon oxidative doping. Conductivities of up to 20 kS/cm have been reported for doped polyacetylene.

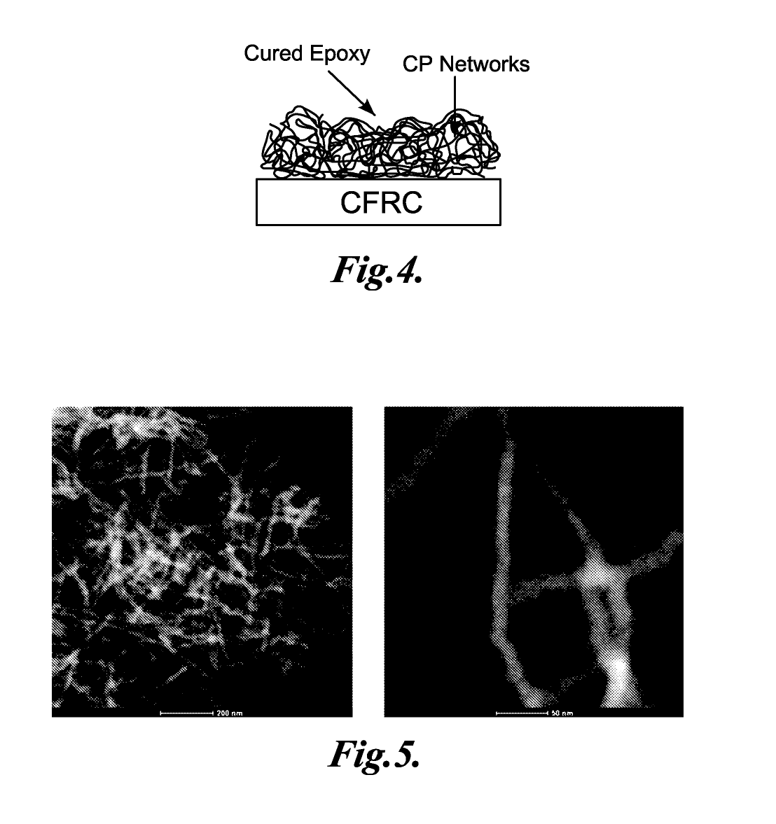

FIG. 4 schematically shows a representative approach useful to generate all-organic conductive coatings. FIG. 4 also shows P3HT nanofiber network dispersions in epoxy carriers and cured coatings.

In certain embodiments, the disclosed composites are useful for the dissipation of currents arising from EME events related to static charge buildup and lightning (e.g. corona discharge, streamers and continuing currents). One advantage of these conductive additives is that they can be easily incorporated into CFRC finishes of vehicles (e.g., airplanes) so that most exposed areas of the vehicle could benefit from EME protection. In one embodiment, the liquid matrix is selected from the group consisting of a polymerizable resin, an oil-based paint, and an oil-based primer.

Accordingly, in another aspect, an electromagnetic effect (EME) management system for a vehicle exterior is provided. In one embodiment, the EME management system includes:
an exterior surface of a vehicle; and
a composite layer disposed on the exterior surface, the composite layer comprising a network of conductive polymer nanofibers in a solid polymer matrix.

In one embodiment, the solid polymer matrix is configured to be applied to the exterior surface as a liquid coating.

In certain embodiments, the CP nanostructures can be added directly to existing formulations (e.g. polyurethanes or epoxies) that have been optimized for mechanical properties, adhesion, durability, and cure-time so that commercial implementation is straightforward.

Some CPs formulations, such as poly(3,4-ethylenedioxythiophene) doped with poly(styrene sulfonate) (PEDOT:PSS; BaytronP from Bayer) have been used in antistatic applications and in transparent coatings for organic solar cells and electronic displays. However, these coatings are usually composed of pure PEDOT:PSS so that film properties (e.g. adhesion) are largely determined by the CP and are not adequate for vehicle finishes. PEDOT:PSS is also insoluble in most solvents and application is normally in the form of spherical particle dispersions where there is little ability to optimize the morphology and where high weight fractions are necessary to achieve percolation. In contrast, polythiophenes (e.g. P3HT) and organic-soluble CPs show rich structural behavior that can translate into significant improvements in electronic properties (e.g. nanofiber networks shown in FIG. 3).

### Procedures for Making Representative Composites

Step 1: Preparation of Fiber Network Dispersions from Conjugated Polymers

Scheme 1: Colloidal Dispersions Self-Assembled Using Temperature Change

First, a conjugated polymer such as, poly-3-alkyl-thiophene (e.g., poly-3-hexyl-thiophene; P3HT), poly di-alkyl fluorene, poly dithienosilole vinylene, or poly dithienosilole thiazolothiazole thiophene, is dissolved in an organic solvent that can be composed of a pure aromatic molecule (e.g. xylene, toluene, or benzene), an alkane (e.g. decane, dodecane, or hexadecane), a halogenated molecule (e.g. dichlorobenzene, chloroform), or a mixture of one or more of these molecules. Because conjugated polymers have limited solubility, the samples must often be dissolved at a high temperature (e.g. >80° C. for P3HT in xylene or >120° C. for P3HT in dodecane). The total concentration of polymer in the solution is selected to be low (typically <1 wt %) to prevent the formation of an elastic gel when the temperature is lowered. For P3HT in xylene, the gel point is about 0.5 wt %.

Next, the temperature of the hot dissolved polymer solution is lowered to a value that induces self-assembly. For P3HT in xylene, this value is usually <60° C. The temperature that is used to induce polymer self-assembly will vary depending on the specific type of polymer and solvent that is being used. The temperature can be lowered rapidly and held fixed at a particular value or it can be lowered gradually using a temperature ramp. Depending on the temperature, solvent, polymer type and concentration that is used, the final structure of the self-assembled polymer can be manipulated.

Next, the sample is allowed to undergo self-assembly for a total duration that can range from a few minutes to several days. The result is a stable and fluid colloidal dispersion of conjugated polymer nanofiber networks such as those shown in FIG. 5. The size and dimensions of the dispersed fibers and the networks is controllable by modifications to the polymer chemistry (monomer type), the molecular weight, the self-assembly temperature and the solvent.

In one embodiment, the colloidal dispersion is formed by self-assembly through the gradual change of solvent composition selected from the group consisting of alkanes, aromatics, and halogenated organic molecules.

Scheme 2: Colloidal Dispersions from Organogel Self-Assembly and Fragmentation

The first step is identical to the first step of Scheme 1 above, with the following exception. The total concentration of polymer in the solution is selected to be relatively high (typically >1 wt %) to form an elastic gel when the temperature is lowered and self-assembly occurs. For P3HT in xylene, the gel point is about 0.5 wt %.

Next, a step identical to the second step of Scheme 1 is performed, but a gel is formed instead of a fluid colloidal dispersion, due to the high polymer concentration in solution.

Next, the sample is allowed to undergo self-assembly for a total duration that can range from a few minutes to several days. The result is an elastic conjugated polymer nanofiber network or organogel.

The solvent that was used to form the gel network in the previous steps can be replaced (if desired) with a different solvent by adding the new solvent to the top of the sample and allowing for diffusion to occur. The new solvent is chosen to not dissolve the self-assembled polymer network. Several consecutive changes of this solvent “cap” can be used to fully replace the original solvent.

Finally, the gel sample is fractured mechanically. The method of gel fracture can be manual mixing, high-shear mixing or compounding, ultrasound fragmentation, extrusion or any other mechanical mechanism. The final particle size is determined by the method used to fragment the gels.

The fragmented gels result in a colloidal dispersion, similar to that of Scheme 1. The final concentration of the dispersion can be reduced by adding an adequate amount of solvent before the fragmentation process is initiated. The result is a stable colloidal dispersion of nanofiber networks.

Step 2: Chemical Doping of Network Dispersions

The nanostructures are chemically doped after inducing self-assembly and formation of fiber networks in Step 1.

FIG. 1E illustrates the issues associated with chemical doping when it is performed before self-assembly. Because doping results in the formation of a strongly associated anion-cation pair, the new polymer structure is altered and self-assembly is prevented. The structure and conductivity of samples doped before self-assembly differs from that of samples that are doped after self-assembly, indicating the importance of maintaining structural control.

The following scheme is used to dope colloidal dispersions or gels prepared as described in Step 1.

Typical doping molecules for conjugated polymers (p-type) are small molecules (e.g. iodine), organic soluble sulfonic acids (e.g. dodecyl-benzene sulfonic acid or DBSA) or ionic polymers (e.g. partly sulfonated polystyrene). The doping molecules are added directly to the conjugated polymer colloidal dispersions at a specified molar ratio with respect to the total number of monomers present in the conjugated polymer sample. For this application, larger doping molecules (e.g. DBSA or sulfonated polystyrene) are typically used because smaller molecules (e.g. iodine) can slowly leach out from the self-assembled conjugated polymer structure and this can reduce the electrical conductivity over time. Colloidal stability is maintained after doping, but sonication or mechanical agitation can also be used to increase dispersion quality.

In one embodiment, the chemical dopant is selected from the group consisting of oxidizing agents including iodine, organic soluble sulfonic acids (e.g., dodecyl benzyl sulfonic acid), water-soluble sulfonic acids (e.g., p-toluene sulfonic acid), organic salts (e.g., iron III tosylate), and acidic polymers (e.g., polystyrene sulfonate in acid form).

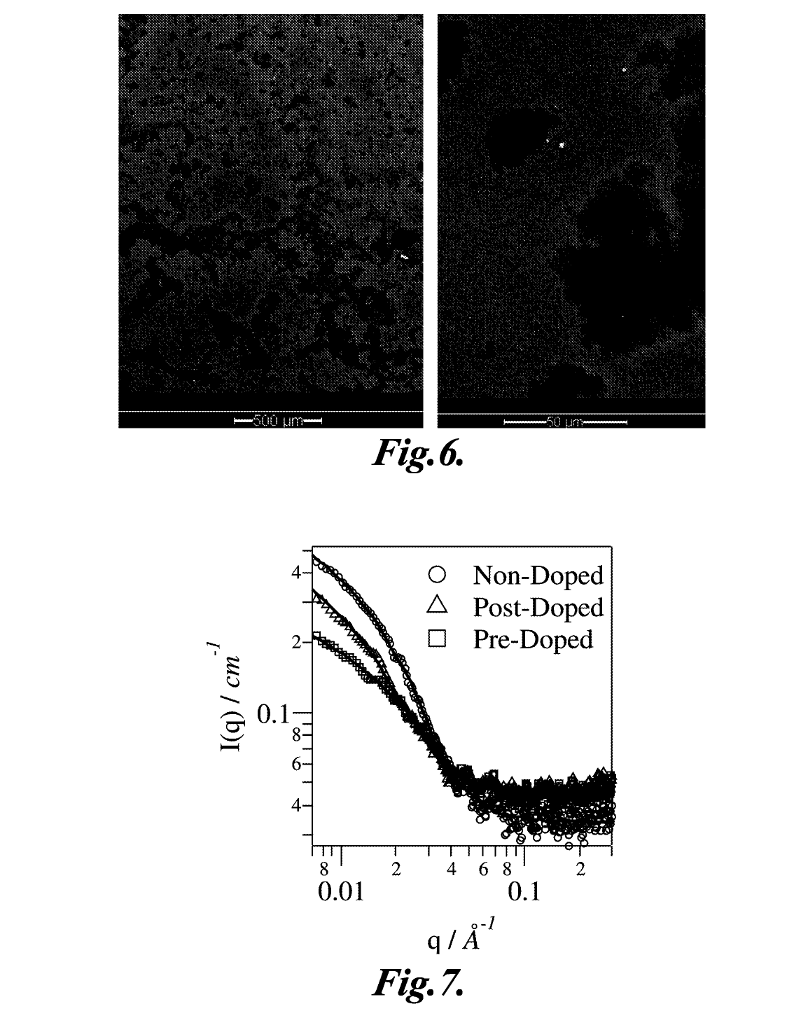

FIG. 6 shows SEM images of deposited colloidal particles (produced using Step 1, Scheme 1) after doping with iodine in excess after inducing self-assembly in xylene at 20° C. The large colloidal particles are visible but the individual fibers are too small to resolve.

FIG. 7 and Table 1 show the results of small angle X-ray scattering (SAXS) experiments demonstrating that the fiber structure is preserved when doping is performed after self-assembly, but it is significantly affected when it is performed before self-assembly. The samples of FIG. 7 are P3HT self-assembled in toluene at a concentration of 0.2 wt % and at a temperature of −20° C. after dissolution at 80° C. The SAXS model fit in Table 1 demonstrates that fiber structure (thickness) is preserved when nanostructures are doped with iodine after self-assembly. When doping is performed before self-assembly the fibers are thinner and narrower.

TABLE 1
Results of SAXS fits to rectangular fiber model for P3HT self-
assembled in toluene with I₂ dopant added before and after assembly.

| | | Post-Assembly | Pre-Assembly |
|---|---|---|---|
| | Non-Doped | Doped | Doped |
| Fiber Height (nm) | 7.7 ± 0.2 | 7.8 ± 0.4 | 6.6 ± 0.5 |
| Fiber Width (nm) | 16.1 ± 0.6 | 21.0 ± 1.8 | 12.6 ± 0.9 |

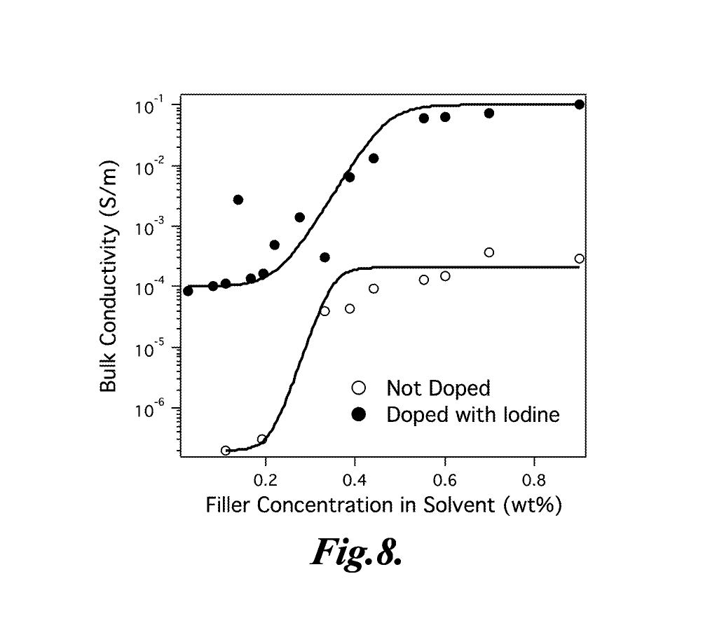

The extent of doping can also be monitored and optimized by measuring the bulk conductivity of the dispersions (FIG. 8). FIG. 8 illustrates bulk conductivity of nanostructured P3HT colloidal networks, formed in xylene through a temperature change, as a function of concentration and doping (excess iodine). Percolation thresholds are in the range of 0.3 to 0.6 wt % filler. Chemical doping is associated with a sharp enhancement of conductivity, where increases by factors of 10-1,000 or more are typical.

Step 3: Dispersion of Doped Conjugated Polymer Nanostructures in Paints, Primer or Organic Resins.

Samples prepared via Steps 1 and 2 are dispersed into a polymerizable resin (e.g. epoxy BADGE) or an oil-based paint or primer formulation (e.g. polyurethane) by following these steps. Other possible matrix materials include polysiloxanes, acrylics, laquers, shellacs, alkyds, phenolic resins, dissolved polymers (e.g. polystyrene or polybutadiene) as well as polymerizable monomers such as styrene.

First, the doped conjugated polymer nanostructures are prepared by dispersing in a solvent that is miscible with the binder, paint or primer that will be modified (made conductive). This can be achieved by centrifugation, filtration or evaporation of the original solvent of the conjugated polymer nanostructure followed by the addition of the desired amount of miscible solvent.

To achieve total re-dispersion of the conductive network, it is optional to apply some external mechanical force via ultrasound or high-shear mixing.

The first steps can also be used to increase the concentration of the conductive filler (the conjugated polymer nanostructure) via re-dispersion in a smaller quantity of new solvent. Total removal of solvent should be avoided because it can cause the irreversible collapse of the colloidal network particles and a more compact structure will result in larger percolation thresholds and lower conductivity. Also, it is desirable to concentrate the colloidal networks as much as possible so that the addition of the additive does not cause the excessive dilution of the carrier paint or resin. Thus, samples should be concentrated as much as possible while maintaining colloidal stability and allowing for homogeneous dispersion in the carrier. This is the optimum formulation. Conditions will vary for different polymers, dopants and colloidal network structures.

In one embodiment, the step of dispersing the colloidal dispersion within the liquid matrix comprises dilution of the matrix and colloidal dispersion with a volatile organic solvent followed by concentration via solvent evaporation using heat or vacuum.

In one embodiment, the step of dispersing the colloidal dispersion within the liquid matrix comprises sonication or mechanical blending.

After the filler additive is available in a miscible solvent at the desired concentration, it is added to the carrier and mixed thoroughly to ensure homogeneous dispersion. If the addition of the filler causes unwanted dilution of the carrier, the original concentration can be obtained through the evaporation of the solvent.

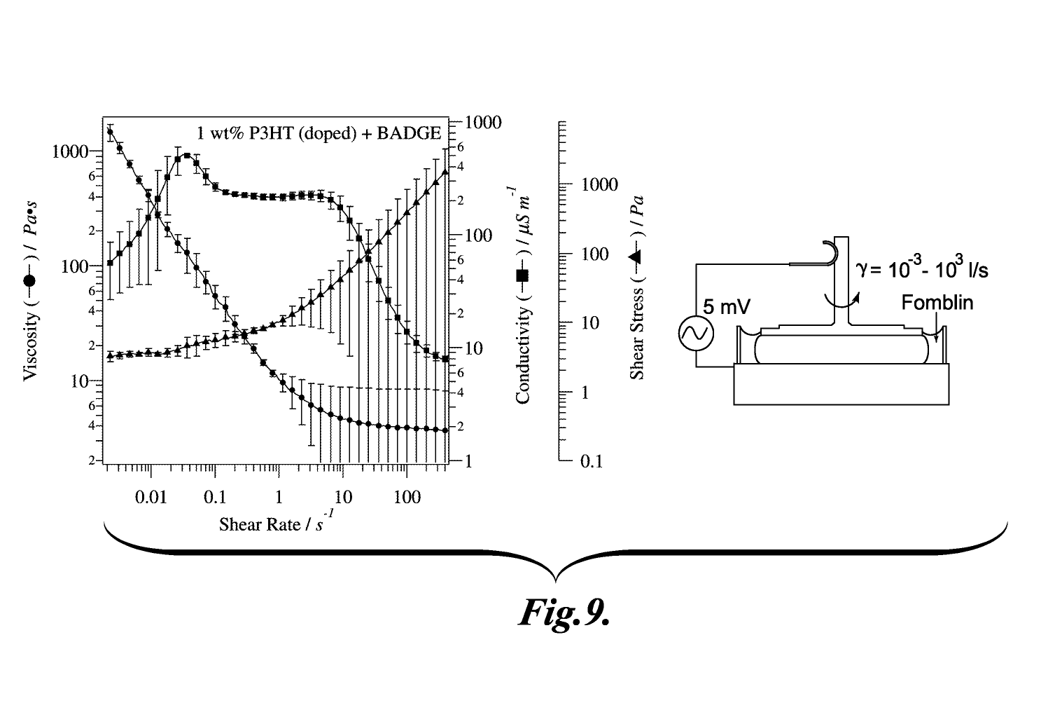

The dispersion of nanostructured conductive fillers in epoxy resins is demonstrated in FIG. 9, which illustrates bulk conductivity of P3HT dispersion doped with iodine (in excess) and dispersed in pure epoxy precursor (BADGE or bisphenol A diglycidyl ether) as a function of shear rate. Measurement is performed in a rheometer with 25 mm parallel plates. Conductivity improves or is maintained during shear flow up to shear rates of 10 s⁻¹.

The conductivity of the carrier BADGE by itself is only 0.01 S/m. When, 1 wt % of P3HT nanostructures doped with iodine are added, the conductivity increases to a rest value (zero-shear) of 56 S/m.

Furthermore, when shear is applied, the conductivity increases to a maximum value of 504 S/m, suggesting that the filler was further dispersed. At high shear rate values (>10 s⁻¹) a decrease in conductivity is observed suggesting that some fiber breakup may occur upon application of high shear.

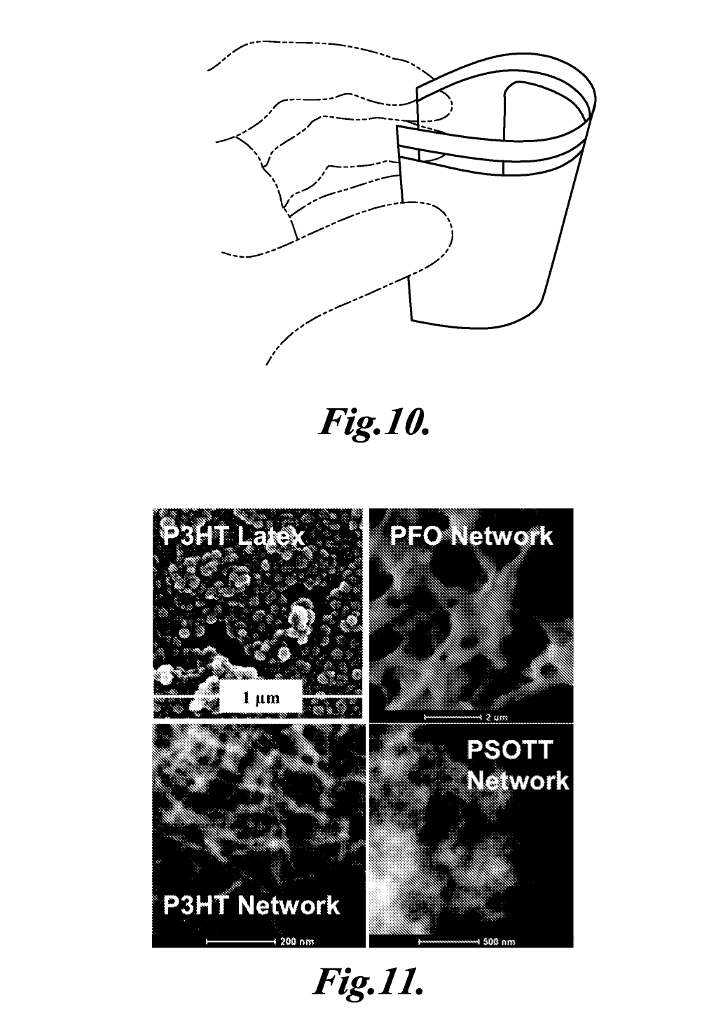

The same procedure was also followed to disperse doped P3HT nanostructures into a commercial polyurethane formulation (Parks Pro-Finisher Polyurethane for Floors Clear). This formulation was then coated using doctor blading to form a homogeneous wet film over a polyethylene terephthalate (PET) substrate with a thickness of 2 mils. The conductive paint was then allowed to dry and the surface resistivity of the conductive coating was measured using the Van der Pauw 4-point probe method. Surface resisitivity values of 1.4×10⁶ Ohm/sq were measured for a conductive filler content of 1 wt % (based on wet sample). Optimization of the network particle size, the dopant additive, the dispersion state and the concentration of filler can further reduce the resisitivity. For reference, the surface resisitivity of PET substrates ranges from 10¹²-10¹⁶ Ohm/sq depending on the relative humidity. Therefore, enhancement of the surface electrical conductivity has been demonstrated. Notably, the mechanical properties of the film (e.g. flexibility and adhesion) are similar to that of the original polyurethane carrier resin. FIG. 10 illustrates the flexibility of a representative sample applied to PET. The sample of FIG. 10 is measured with 4-point probe measurements according to the Van der Pauw method, for P3HT doped with iodine after self-assembly and dispersed at a concentration of 1.2 wt % in a commercial polyurethane formulation. The conductive films are flexible and retain the properties of pure polyurethane films because of the low filler loading fractions.

### Effects of Doping on the Morphology of Conducting Polymer Nanostructures

We have designed model systems that will allow us to systematically analyze and understand the intimate relationship between structure and properties in conductive films prepared from CPs. We have used epoxy resins based on bisphenol A diglycidyl ether (BADGE) and commercial polyurethane formulations as a model matrix materials, but expect the results to also be relevant to other organic matrices used for vehicular finishes. For the CP systems we have primarily used model systems of alkyl substituted polythiophenes and polyfluorenes due to their rich morphological behavior. These polymers have molecular architectures that allow them to exist in various morphological states (e.g. coils, fibers, networks, aggregates and gels) by tuning the self-assembly and aggregation. FIG. 11 presents SEM micrographs of exemplary CP architectures, include P3HT in latex and nanofiber network form; PFO in nanofiber network form, and poly[(4,4′-bis(2-octyl)dithieno[3,2-b:2′3′-d]silole)-2,6-diyl-alt-(2,5-bis(3-octylthiophen-2yl)thiazolo[5,4-d]thiazole)] (PSOTT) in nanofiber network form. These results can be applied to the large diversity of CPs that have been synthesized within the last two decades.

Because our interest is in conductive films, the materials are doped with oxidizing molecules. In this example, we explore two different dopants, iodine and dodecylbenzene-sulfonic acid (DBSA). After the oxidation reaction, dopant molecules usually remain associated to the doped CP forming a macromolecular salt. These two molecules allow us to evaluate the effect of dopant size on the self-assembly and morphology of the CP nanostructures and on the properties of the resulting conductive coatings. We also use PEDOT:PSS dispersions as a benchmark CP material to compare to our coatings. PEDOT:PSS is one of the most effective CP conductors. However, because it requires coating in its pure form, PEDOT:PSS films do not meet rigorous mechanical, environmental and adhesion specifications of vehicular finishes.

Doping of conjugated polymers has been demonstrated to lead to large increases in electronic conductivity. Charge conduction, whether occurring in a doped or un-doped state, requires percolation and is thus intimately tied to the morphology and nanostructure. CPs are ideal materials for charge conduction because they self-assemble into a variety of nanostructures, including nanofibers and networks, when they are dissolved in solvents of intermediate quality. This is driven by 1D crystallization due to π-π stacking interactions.

Doping of CPs is not common. Particularly, most CPs (e.g., P3HT) are targeted for use as semiconducting compounds and doping or oxidation of the compounds is actively avoided. In the disclosed embodiments, however, the CPs are intentionally doped in order to improve conductivity. Undoped CPs integrated into composites as disclosed herein would not provide sufficient EME management materials to solve the problems addressed by the disclosed embodiments.

Doping usually involves the oxidation of CPs leading to the injection of positive charge carriers (i.e. holes) that increase conductivity. The small molecule iodine is frequently used to dope CP films. Doping is also possible with larger acids that are soluble in organic solvents (e.g. DBSA).

One important effect of doping is that the dopant usually remains tightly associated to the polymer and forms an ionic complex that is analogous to a macromolecular salt. Because the dopant remains associated to the polymer, it can obstruct the self-assembly of the CP because it can interfere with π-π stacking interactions. For example, when doping occurs prior to self-assembly (i.e. chains are doped in a dissolved state), bulky dopants (e.g. DBSA) could prevent growth of nanofibers and networks by intercalating between chains and instead lead to disordered aggregation of the CP (FIG. 1E).

These disordered structures lead to lower conductivities. To prevent this, nanofibers are grown via self-assembly in a desired solvent and temperature in the un-doped state. Doping is then performed after self-assembly so that the dopants only decorate the outside of the nanostructures and do not alter the internal morphology. Furthermore, it may also be possible to substantially increase conductivity with smaller dopants (e.g. iodine) or by using lower amounts to avoid affecting the nano-scale morphology. Doping of CPs after the induction of self-assembly allows retention of the original nanostructure and lead to highly conductive materials.

The morphological effects of doping in systems of polythiophene CPs dispersed in aromatic solvents and in BADGE resins were studied. Doping is induced in the aromatic solvents prior-to or after self-assembly of nanofibers and networks by adding variable amounts of DBSA or iodine. Adjusting the level of supersaturation, via changes to temperature or solvent quality, allows effective control of the morphology of nanofibers and branched networks.

### Percolation Behavior of CP Nanostructures

Composite materials incorporating conductive fillers typically show behavior that is distinctive of percolating systems. Random percolation theory, originally introduced in 1957 to describe the flow of fluids through a porous medium, applies statistical analyses and models to describe non-linear changes in macroscopic properties that occur when dispersed materials “percolate” or interconnect through a medium. Conductive nanocomposites, especially those containing additives with high aspect ratio, undergo steep non-linear increases in conductivity with increasing concentration. In this example, we use existing models based on random percolation theory to describe the concentration dependence of the electrical properties of composite materials incorporating CP additives with variable nanostructures (e.g. coils, nanofibers, networks or particles) as shown in FIG. 11. Percolation theory and other models could be especially useful to rationally design nanostructures that maximize electrical conductivity and minimize the required amount of additives and associated costs. These models can also be valuable tools for the formulation of coatings incorporating other types of conductive additives. The current processes that are used to formulate conductive coatings significantly benefit from the fundamental understanding of the governing physical principles.

The conductivity of a material above its percolation threshold (φ_{crit}) can frequently be described with a simple power-law equation: σ=σₒ(φ−φ_{crit})^{t} where σ is the conductivity of the composite, σₒ, is the conductivity of the pure filler material, φ is the volume fraction of filler and t is the critical exponent. In the context of designing conductive finishes, it is desired to minimize the value of φ_{crit} and to maximize the value of t so that smaller amounts of additives are required to achieve the desired properties. Extensive Monte Carlo simulations in two and three dimensions have been performed to theoretically estimate values for φ_{crit} and t for model systems having various shapes and states of orientation. Spheres typically have high percolation thresholds (e.g. 37 vol % for silver particles in Bakelite) and low critical exponents (1.3-2) suggesting that they are not effective shapes for additives. However, the percolation threshold is also affected by particle size and generally increases with larger particle radius. In contrast, randomly oriented conductive fibers have much lower percolation thresholds (e.g. 4.5 vol % for carbon fibers) and higher critical exponents (t>3) due to their elongated shape. This shape leads to large probabilities of fiber overlaps that help to create a conductive path. For fibers, φ_{crit} is again dependent on the fiber radius explaining why carbon nanotubes are such effective conductive additives. In general, nanostructures with high aspect ratios and high surface-to-volume ratios (i.e. small size) result in improved conductivity when randomly packed. However, fiber orientation effects, like those due to shear, can also increase the percolation threshold, lower the critical exponent and generally decrease conductivity.

Nanofiber networks are superior CP nanostructures in conductive coatings because they are formed from elongated fiber subunits that lower percolation thresholds. In addition, they will also be less likely to undergo shear orientation due to their isotropic structures.

Percolation thresholds and critical exponents in networked nanomaterials have not been studied in as much detail as spherical particles and fiber systems because there are fewer conductive additives available that have controllable network structures. Networks of CPs are spontaneously formed when nanofibers branch during the crystallization process due to lattice mismatch defects. The occurrence of defects, and thus the branching frequency, can be manipulated by altering the supersaturation conditions of the polymer. It has been demonstrated that the network morphology can be modified to range from highly branched to loosely branched (even single fibers) by allowing self-assembly to proceed in different solvents or at different temperatures. The branching density can also be quantified by describing CP networks as fractal structures where the number of fibers (N) located in a sphere of radius (r) is described by, N˜r^{D}. The parameter D is commonly known as the fractal dimension and, for three-dimensional systems, its value ranges from 1 (for un-branched fibers) to ˜3 (very dense solid-like networks). The value of D is experimentally accessible has been measured in our laboratory for P3HT nanofiber networks (un-doped) with small angle neutron scattering (SANS). The average network size is also quantified via electron microscopy (e.g. TEM, SEM). Impedance spectroscopy is used to measure the conductivity of samples having different nanostructures, doping levels and concentrations.

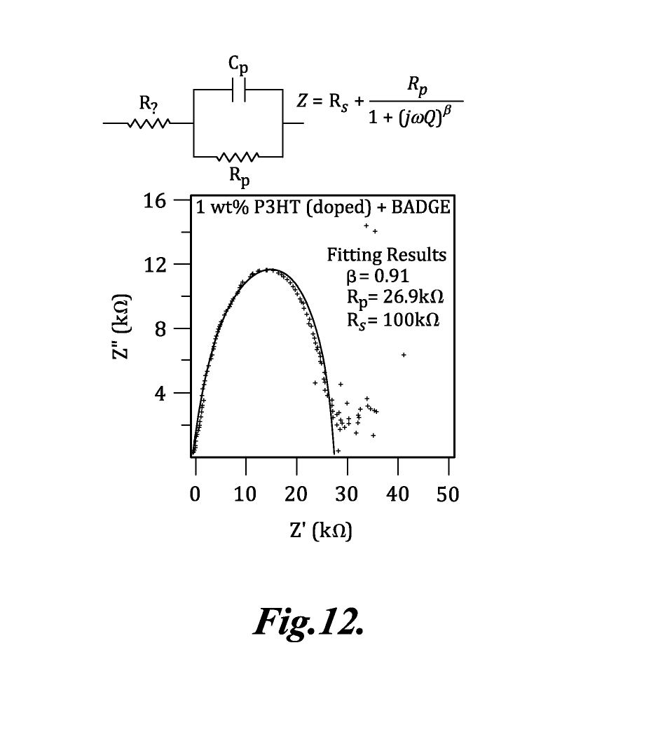

FIG. 12 shows a representative Nyquist plot for a 1 wt % P3HT nanofiber network dispersion in BADGE epoxy resin that was doped with iodine after inducing self-assembly. The impedance spectrum was modeled with a constant phase element (CPE) model corresponding to the equivalent circuit shown in FIG. 12. Impedance analysis allows isolation of all the resistances and capacitances that could affect the measurements in order to ensure that accurate values of the bulk material conductivity and resistivity are obtained.

### Flow-Induced Structural Transitions in Conductive Polymer Coatings

During common coating processes, materials are frequently subjected to high shear rates that can significantly affect the electronic properties of the final finish. In the case of spray coating, which is the most common approach to apply aircraft finishes, the effective shear rate of the fluid being coated can range from 100 to 10,000 s⁻¹. Such high shear fields could result in significant alterations to the morphology and therefore also affect the properties of the final coating. There are two primary mechanisms that could lead to deterioration of electrical conductivity due to flow effects: 1) flow-induced alignment of conductive fillers and 2) shear induced morphological changes of the additives (e.g. network fracture). In this example we discuss the fundamental principles leading to shear-induced transitions in our systems.

Nanofiber networks of CPs will not undergo significant shear-alignment but can and will be fractured when local stress fields exceed a critical value (τ_{c}). In contrast, nanofiber dispersions (i.e. un-branched individual fibers) undergo significant shear-alignment that will lead to deterioration of the electronic properties in the coatings.

Combined structure-property experiments can be used to systematically study the effects of shear on the same systems that we have described in the previous sections. We use a specially configured shear cell that interfaces with a commercial rheometer (Anton Paar MCR 301) to simultaneously perform rheological and impedance spectroscopy analysis (i.e. rheodielectric tests) of CP nanostructures that are dispersed in epoxy resins (BADGE). FIG. 9 shows a schematic and a picture of the setup along with an example of preliminary rheo-dielectric data for P3HT nanofiber networks.

This sample was doped with iodine after self-assembly and dispersed in un-cured BADGE epoxy (1 wt % P3HT). For reference, the conductivity of the neat BADGE resin is just 0.01 μS/m and the value does not change with shear rate. In this experiment, the addition of just 1 wt % of the P3HT nanostructured networks resulted in an increase of more than 50,000 times the conductivity of the epoxy. Notably, this is preliminary data and the samples have not been optimized for doping levels, concentration or morphological parameters. Thus, even larger improvements in conductivity could be expected from optimization.

More importantly, there is a complex dependence of the electrical conductivity with the applied shear-rate for this sample. At low shear rates (<0.04 s⁻¹) there is a steady increase in conductivity that could result from the re-organization of the filler material increasing the probability of network contacts and improving percolation. At intermediate shear rates (0.1-10 s⁻¹) there is a region of constant conductivity.

Finally, at high shear-rates (>10 s⁻¹) there is a steady decrease in conductivity as a function of shear that could indicate the onset of network breakup or orientation effects. The corresponding shear stress where the sharp decrease in conductivity occurs could be related to the critical shear stress (τ_{c}) for network fracture. The conductivity in this sample decreases by ˜60 times from its maximum value indicating that shear effects are significant.

While illustrative embodiments have been illustrated and described, it will be appreciated that various changes can be made therein without departing from the spirit and scope of the invention.

1. A method of forming a composite incorporating networks of conductive polymer nanofibers, the method comprising the steps of:
(a) providing a colloidal dispersion comprising a self-assembled network of nanofibers comprising a conjugated polymer;
(b) doping the conjugated polymer with a chemical dopant to provide conductive polymers within the self-assembled network of the colloidal dispersion; and
(c) dispersing the colloidal dispersion within a liquid matrix to provide a liquid composite comprising a network of conductive polymer nanofibers, wherein the liquid matrix is selected from the group consisting of a polymer and a polymer precursor.

2. The method of claim 1 further comprising a step of solidifying the liquid composite to provide a solid composite comprising the network of conductive polymer nanofibers in a solid polymer matrix.

3. The method of claim 1, wherein the colloidal dispersion is formed by temperature-induced self-assembly of the conjugated polymer in a solution.

4. The method of claim 1, wherein the colloidal dispersion is a fluid colloidal dispersion.

5. The method of claim 1, wherein the colloidal dispersion is prepared from the mechanical fracture of a gel.

6. The method of claim 5, wherein the gel is an elastic organogel comprising the self-assembled network of the conjugated polymer.

7. The method of claim 1, wherein the colloidal dispersion is formed by self-assembly through the gradual change of solvent composition selected from the group consisting of alkanes, aromatics, and halogenated organic molecules.

8. The method of claim 1, wherein the conjugated polymer is a semiconducting polymer.

9. The method of claim 1, wherein the conjugated polymer is selected from the group consisting of a polyalkylthiophene, a polydi-alkyl fluorene, a polydithienosilole, a polyphenylene, a poly(3,4-ethylenedioxythiophene), a poly(pyrrole), a polypyrene, a polypyridine, a poly(p-phenylene vinylene), a polycarbazole, a polyaniline, a polyindole or a copolymer of the polymers listed within this group.

10. The method of claim 1, wherein the chemical dopant is selected from the group consisting of oxidizing agents including iodine, organic soluble sulfonic acids, water-soluble sulfonic acids, organic salts, and acidic polymers.

11. The method of claim 1, wherein the liquid matrix is selected from the group consisting of a polymerizable resin, an oil-based paint, and an oil-based primer.

12. The method of claim 1, wherein the step of dispersing the colloidal dispersion within the liquid matrix comprises dilution of the matrix and colloidal dispersion with a volatile organic solvent followed by concentration via solvent evaporation using heat or vacuum.

13. The method of claim 1, wherein the step of dispersing the colloidal dispersion within the liquid matrix comprises sonication or mechanical blending.

14. The method of claim 1, wherein the network of conductive polymers nanofibers comprises fibers having an individual length of from 50 nm to 5 microns.

15. The method of claim 1, wherein the network of conductive polymers nanofibers comprises fibers having a cross-sectional dimension of from 5 nm to 200 nm.

16. The method of claim 1, wherein the network of conductive polymers nanofibers comprises fibers having a plurality of branch points spaced between 200 nm to 5 microns apart.

17. The method of claim 1, wherein the colloidal dispersion is from 1 micron to 1 mm in size.

18. An electromagnetic effect management system for a vehicle exterior, comprising:
an exterior surface of a vehicle; and
a composite layer disposed on the exterior surface, the composite layer comprising a network of conductive polymer nanofibers in a solid polymer matrix, wherein the solid polymer matrix is configured to be applied to the exterior surface as a liquid coating.

19. (canceled)

20. The electromagnetic effect management system of claim 18, wherein the network of conductive polymer nanofibers is formed using a method of forming a composite incorporating networks of conductive polymer nanofibers, the method comprising the steps of:
(a) providing a colloidal dispersion comprising a self-assembled network of nanofibers comprising a conjugated polymer;
(b) doping the conjugated polymer with a chemical dopant to provide conductive polymers within the self-assembled network of the colloidal dispersion; and
(c) dispersing the colloidal dispersion within a liquid matrix to provide a liquid composite comprising a network of conductive polymer nanofibers, wherein the liquid matrix is selected from the group consisting of a polymer and a polymer precursor.
